(19) United States
(12) Patent Application Publication
(10) Pub. No.: US 2010/0263542 A1
(43) Pub. Date: Oct. 21, 2010

(54) FRAME FLANGE ATTACHABLE TO A FILTER CARTRIDGE TO FORM A FILTER ASSEMBLY

(76) Inventors: Dwight H. Heberer, Brownsburg, IN (US); Kevin H. Waldo, Greenwood, IN (US); Edward C. Sofsky, Foley, AL (US); Danny L. Jenkins, Camby, IN (US); Richard Joseph Scott, III, Fairhope, AL (US)

Correspondence Address: CARLSON, GASKEY & OLDS, P.C., 400 WEST MAPLE ROAD, SUITE 350, BIRMINGHAM, MI, 48009, US

(21) Appl. No.: 12/741,235

(22) PCT Filed: Feb. 1, 2008
(86) PCT No.: PCT/US08/52764

§ 371 Date: May 4, 2010

(51) Int. Cl. B01D 50/00; B01D 46/10

(52) U.S. Cl. 96/407; 55/504

(57) ABSTRACT

A filter assembly is used in a return air grille of an HVAC system to filter dust, particles and contaminants from air. The filter assembly includes a filter cartridge having a frame that surrounds an air filter. The frame includes a planar surface that defines a plane. The filter cartridge and the frame flange are separate components. A frame flange is attached only to the planar surface of the frame.

### BACKGROUND OF THE INVENTION

The present invention relates generally to a filter assembly of an HVAC system including a separate frame flange that is attachable to a frame of a filter cartridge to prevent the bypass of air around the filter cartridge.

An HVAC system includes a climate control device that adjusts a temperature of air in a space. For example, the climate control device can be a furnace that heats air or an air conditioner that cools air. The air flows through a filter cartridge of a return air grille to remove any dust, particles or contaminants in the air before flowing into the climate control device. The filter cartridge includes a pleated air filter and a frame that surrounds the pleaded air filter.

In a one prior filter cartridge, a flange is integrated as a single component with a portion of the frame to prevent the bypass of air around the filter cartridge. In another prior filter cartridge, the flange is attached to multiple surfaces of the frame.

### SUMMARY OF THE INVENTION

A filter assembly of a return air grille of an HVAC system filters dust, particles and contaminants from air. The filter assembly includes a filter cartridge having a frame that surrounds an air filter. The frame has a planar surface that defines a plane. A frame flange is attached to only the planar surface of the frame. The filter cartridge and the frame flange are separate components.

The surface can be an air entering surface that is substantially perpendicular to a direction of airflow towards the filter assembly. The frame flange surrounds an entire perimeter of the frame of the filter cartridge. Both the frame and the frame flange can be made of beverage board. The frame flange is attached to the frame by an adhesive. A strip of foam can be applied to an air exiting surface of the frame to provide an additional seal between the frame flange and the return air grille.

In one example, the frame flange is entirely located on one side of the plane defined by the planar surface. In another example, a cantilever flange portion attached to the frame flange extends at an angle relative to the frame flange to provide additional sealing between the frame flange and the return air grille.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 schematically illustrates an HVAC system;

FIG. 2 schematically illustrates a perspective view of a filter cartridge;

FIG. 3 schematically illustrates a perspective view of a first example frame flange;

FIG. 4 schematically illustrates a perspective view of a first example filter assembly;

FIG. 5 schematically illustrates a side view of the first example filter assembly;

FIG. 6 schematically illustrates a side view of another installation of the frame flange of the first example;

FIG. 7 schematically illustrates a perspective view of a second example filter assembly;

FIG. 8 schematically illustrates a strip that is used to form a second example frame flange;

FIG. 9 schematically illustrates an enlarged view of a corner section shown in FIG. 8;

FIG. 10 schematically illustrates an enlarged view of a first half corner section shown in FIG. 8;

FIG. 11 schematically illustrates an enlarged view of a second half corner section shown in FIG. 8;

FIGS. 12, 13 and 14 schematically illustrate the steps of forming the second example frame flange from the strip;

FIG. 15 schematically illustrates a front view of the second example frame flange; and

FIG. 16 schematically illustrates a side view of the second example filter assembly.

### DETAILED DESCRIPTION OF THE PREFERRED EMBODIMENT

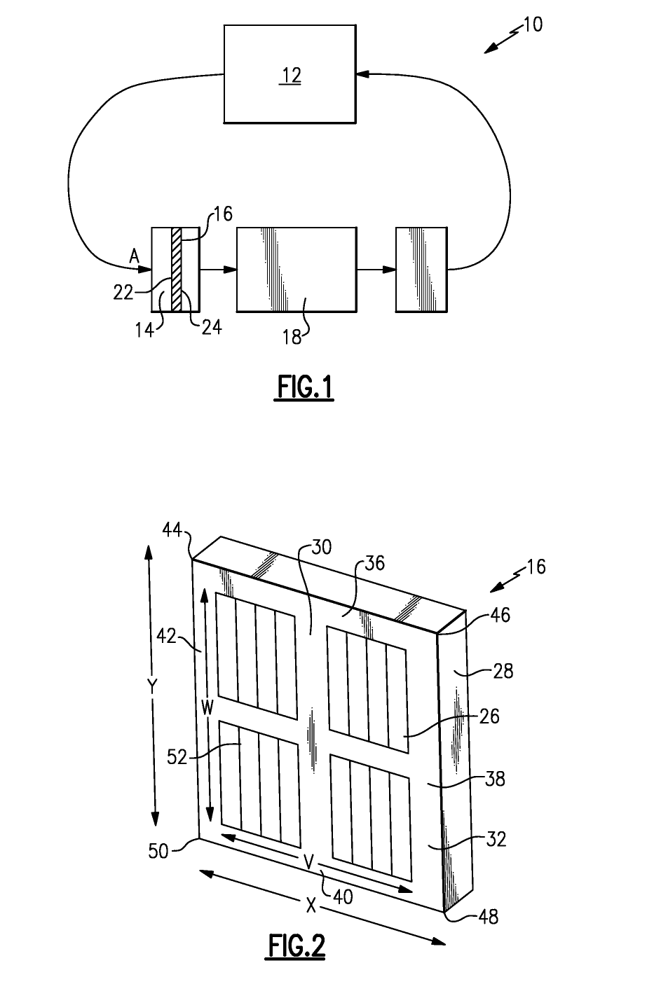

FIG. 1 illustrates an HVAC system 10 or a climate control system. Air from a space 12 is drawn through a return air grille 14. The air flows through a filter cartridge 16 that is received in the return air grille 14 to remove any dust, particles, contaminants, etc. in the air. The air enters the filter cartridge 16 in a direction A from an inlet side 22 and exits the filter cartridge 16 from an outlet side 24. The air is then directed into a climate control device 18 that heats or cools the air. For example, if the climate control device 18 is a furnace, the air is heated. If the climate control device 18 is an air conditioner, the air is cooled. After the air is heated or cooled, the air flows through a supply air grille 20 and is directed to the space 12, completing the cycle.

As shown in FIG. 2, the filter cartridge 16 includes a pleated air filter 26 received in a frame 28. In one example, the frame 28 is made of beverage board or heavy gauge beverage board. The filter cartridge 16 can also include cross-beams 30 that provide structure. The cross-beams 30 can also be made of beverage board or heavy gauge beverage board.

In one example, the filter cartridge 16 is substantially rectangular or square in shape and has a width of x and a height of y. In one example, the filter cartridge 16 is a one inch disposable filter cartridge 16. The pleated air filter 26 can be a deep pleat cartridge filter.

The frame 28 includes a planar air entering surface 32 and an opposing air exiting surface 34 (shown in FIG. 5). The air entering surface 32 and the air exiting surface 34 define parallel planes and are substantially perpendicular to the direction A of air flow. The air entering surface 32 of the frame 28 includes a first surface 36, a second surface 38, a third surface 40 and a fourth surface 42. The first surface 36 and the third surface 40 are substantially parallel and have the width x, and the second surface 38 and the fourth surface 42 are substantially parallel and have the height y. The frame 28 also defines a first corner 44, a second corner 46, a third corner 48 and a fourth corner 50. The frame 28 defines an opening 52 that exposes the pleated air filter 26. An outer perimeter of the air entering surface 32 of the frame 28 has the width x and the height y, and an inner perimeter of the air entering surface 32 of the frame 28 that defines the opening 52 has a length v and a height w.

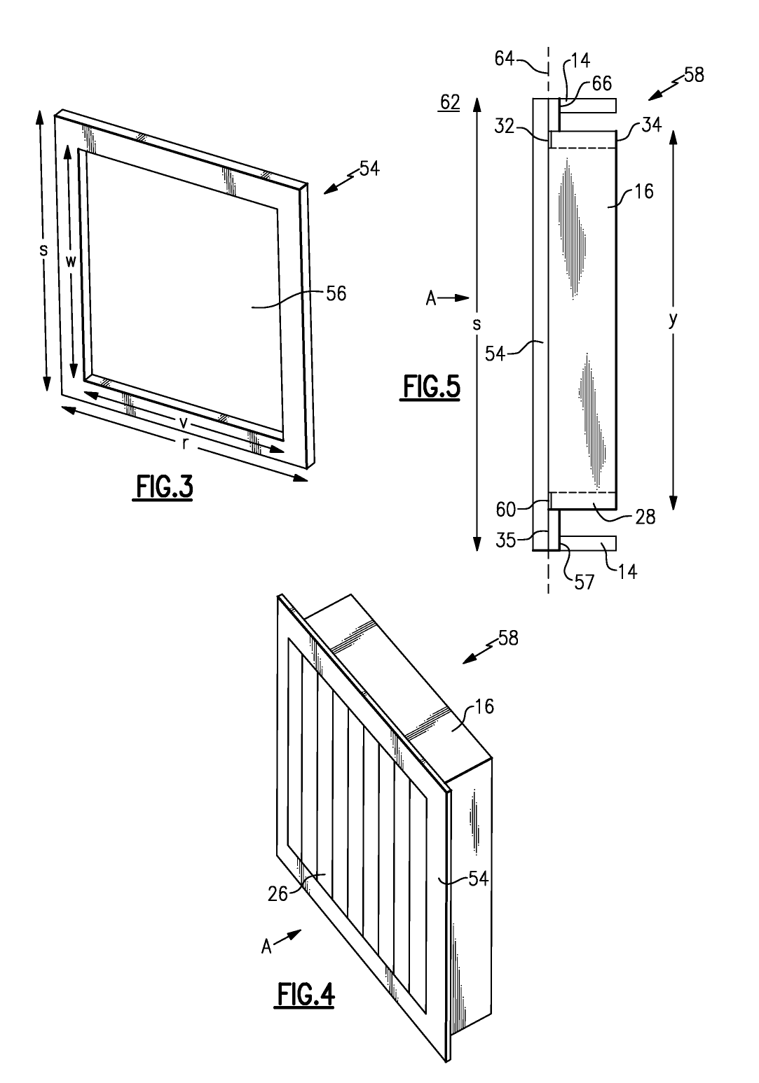

FIG. 3 shows a first example frame flange 54 that can be attached to the frame 28. The perimeter frame flange 54 can be made of a beverage board or heavy gauge beverage board. The frame flange 54 is planar and includes a body portion 55 made of a single piece of material that defines an opening 56. The dimensions of the opening 56 are generally equal to the dimensions v and w of the inner perimeter of the frame 28 so that the frame flange 54 does not affect airflow through the pleated air filter 26. The frame flange 54 has a width r and a height s. If the filter cartridge 16 is rectangular or square, the frame flange 54 is also rectangular and square, respectively, and has dimensions proportional to the dimensions of the filter cartridge 16. The frame flange 54 surrounds the entire perimeter of the frame 28 of the filter cartridge 16 and extends outwardly from the outer perimeter of the frame 28. That is, the width r is greater than the width x of the frame 28, and the height s is greater than the height y of the frame 28.

The frame flange 54 is attached to the air entering surface 32 of the frame 28 of the filter cartridge 16 to form a filter assembly 58 (shown in FIGS. 4 and 5). In another example, the frame flange 54 is attached to the air exiting surface 34 of the frame 28. Alternatively, the frame flange 54 is attached to the air entering surface 32 and another frame flange (not shown) is attached to the air exiting surface 34 of the frame 28. The frame flange 54 and the filter cartridge 16 are separate components.

As shown in FIG. 5, the frame flange 54 is attached to the frame 28 by an adhesive 60, such as glue. The frame flange 54 is attached to and extends outwardly from all four surfaces 36, 38, 40 and 42 of the planar air entering surface 32 of the filter cartridge 16. When attached, the frame flange 54 is located only on one side 62 of a plane 64 defined by the air entering surface 32 of the frame 28. That is, the frame flange 54 is only attached to a single surface of the frame 28 (the planar air entering surface 32), which defines the entirety of the contact area of the frame flange 54 and the frame 28.

Foam 66 is applied to a surface of the frame flange 54 to provide additional sealing. In one example, the foam 66 is a peel off foam strip that is cut to a desired length and applied to the air exiting surface 35 of the frame flange 54 that faces away from the direction A of air entry. In one example, the foam 66 is a one inch thick strip of foam that provides adaptability to a wide variety of return air grilles 14 to provide an additional seal against air bypass around the filter cartridge 16, improving the efficiency and dust holding capacity of the filter cartridge 16.

Alternately, as shown in FIG. 6, an outer surface 68 of the frame 28 of the filter cartridge 16 is received in the opening 56 of the frame flange 54. The frame flange 54 is secured to the frame 28 by the adhesive 60.

When assembled, the frame flange 54 is secured to the filter cartridge 16. The foam 66 can be applied to the air exiting surface 35 of the frame flange 54. The filter assembly 58 is then installed in the return air grille 14. The frame flange 54 fits the track designed for standard one inch filter cartridges 16. The frame flange 54 reduces the bypass of air around the outer surface of the filter cartridge 16. The foam 66 presses against a surface 57 of the return air grille 14, creating an additional seal that also reduces the bypass of air around the filter cartridge 16.

The frame flange 54 and the foam 66 can be applied to the filter cartridge 16 at the manufacturing plant. Alternately, the frame flange 54 and the foam 66 can be sold as a separate after mark product and applied to the filter cartridge 16 by a consumer or an installer after purchase of the filter cartridge 16.

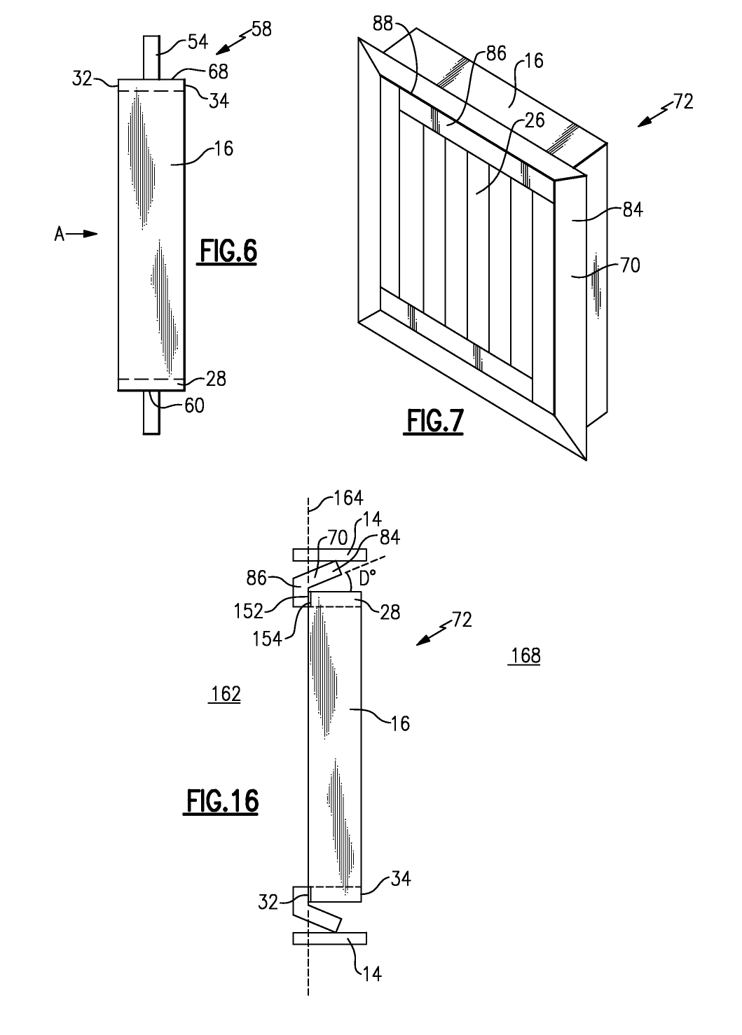

FIG. 7 illustrates a second example frame flange 70 attached to the frame 28 of a filter cartridge 16 to form a filter assembly 72. The frame flange 70 is a cantilever frame flange including an attachment portion 86 attached to the frame 28 and a flange portion 84 extending at an angle relative to the attachment portion 86. In one example, the filter cartridge 16 is rectangular or square, and the frame flange 70 is rectangular or square, respectively.

As shown in FIG. 8, the frame flange 70 is formed from a strip 74 of beverage board or heavy gauge beverage board. The strip 74 is an elongated rectangular piece of material made of a single component. The strip 74 includes a first longitudinal edge 76, an opposing second longitudinal edge 78 parallel to the first longitudinal edge 76, a first end 80 and an opposing second end 82.

The flange portion 84 and the attachment portion 86 are separated by a longitudinal score line 88, which allows the flange portion 84 and the attachment portion 86 to bend relative to each other. The strip 74 includes a first corner section 90, a second corner section 92 and a third corner section 94 that allow the strip 74 to bend approximately 90° at each corner section 90, 92 and 94 to form the frame flange 70. The strip 74 also includes a first half corner section 96 and a second half corner section 98 located at ends 80 and 82, respectively, of the strip 74.

A first section 140 is defined between the first half corner section 96 and the first corner section 90, a second section 142 is defined between the first corner section 90 and the second corner section 92, a third section 144 is defined between the second corner section 92 and the third corner section 94, and a fourth section 146 is defined between the third corner section 94 and the second half corner section 98.

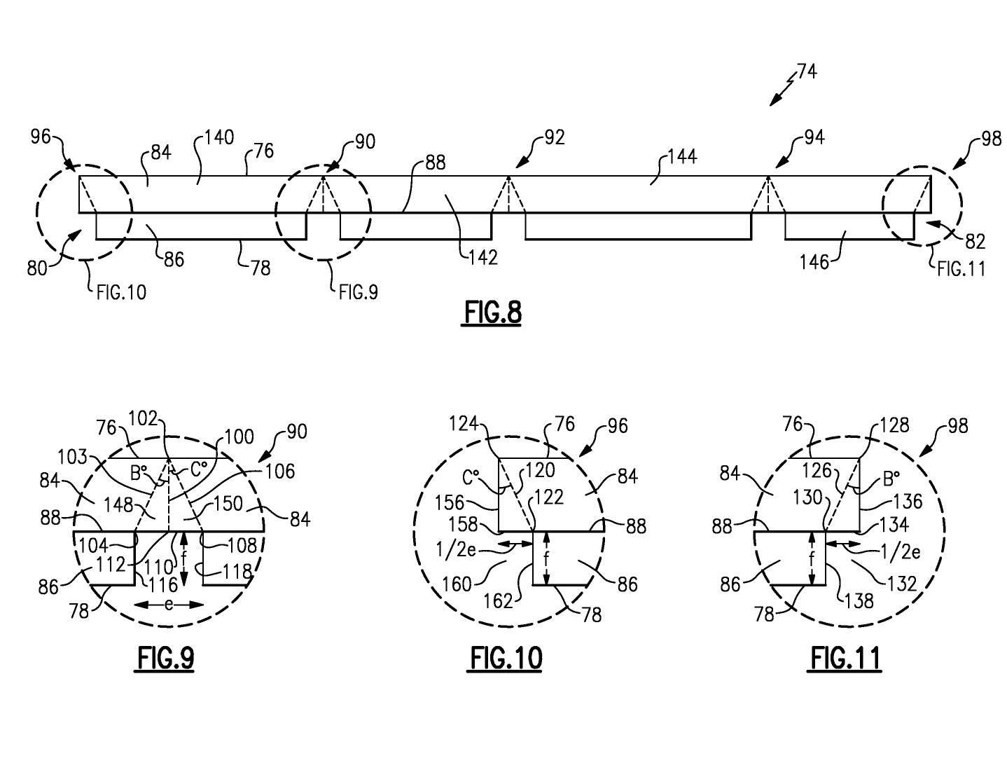

FIG. 9 shows an enlarged view of the first corner section 90 shown in FIG. 8. Although only the first corner section 90 is illustrated, the corner sections 92 and 94 have the same features.

The flange portion 84 of the first corner section 90 includes a first score line 100 that extends perpendicular from a point 102 on the first longitudinal edge 76 of the strip 74 to the longitudinal score line 88, a second score line 103 that extends at an angle B° from the point 102 to a point 104 on the longitudinal score line 88, and a third score line 106 that extends at an angle C° from the point 102 to a point 108 the longitudinal score line 88. The angles B° and C° are approximately equal. The second score line 103, the third score line 106, and a section 110 of the longitudinal score line 88 between the points 104 and 108 form an isosceles triangle.

The first score line 100 extends from the point 102 to a point 112 on the longitudinal score line 88 that is in the middle of the points 104 and 108. A first triangle 148 is defined by the first score line 100, the second score line 103, and the part of the section 110 of the longitudinal score line 88 between the points 104 and 112, and a second triangle 150 is defined by the first score line 100, the third score line 106, and the part of the section 110 of the longitudinal score line 88 between the points 112 and 108. The first triangle 148 and the second triangle 150 together form the isosceles triangle.

The attachment portion 86 of the first corner section 90 includes a rectangular notch 114. The notch 114 is defined by a first edge 116, a second edge defined by the section 110 of the longitudinal score line 88 and a third edge 118.

The first edge 116 extends perpendicularly from the second longitudinal edge 78 of the strip 74 to the point 104 on the longitudinal score line 88, and the third edge 118 extends perpendicularly from the second longitudinal edge 78 of the strip 74 to the point 108 at the longitudinal score line 88. The notch 114 has a width e and a height f.

FIG. 10 shows an enlarged view of the first half corner section 96 shown in FIG. 8. The flange portion 84 of the first half corner section 96 includes a single score line 120 that extends from a point 124 at an end of the first longitudinal edge 76 to a point 122 on the longitudinal score line 88 at an angle C° from an end edge 156 of the attachment portion 86.

The attachment portion 86 of the first half corner section 96 includes a notch 160 including a first edge 158 that is a continuation of the longitudinal score line 88 that extends from the end edge 156 to the point 122 and a second edge 162 that extends perpendicularly from the point 112 to the second longitudinal edge 78. The notch 160 has a width ½e and a height f.

FIG. 11 shows an enlarged view of the second half corner section 98 shown in FIG. 8. The flange portion 84 of the second half corner section 98 includes a single score line 126 that extends from a point 128 at an end of the first longitudinal edge 76 to a point 130 on the longitudinal score line 88 at an angle B° from an end edge 136 of the attachment portion 86.

The attachment portion 86 of the first half corner section 96 includes a notch 132 including a first edge 134 that is a continuation of the longitudinal score line 88 that extends from the end edge 136 to the point 130 and a second edge 138 that extends perpendicularly from the point 130 to the second longitudinal edge 78. The notch 132 has a width ½e and a height f.

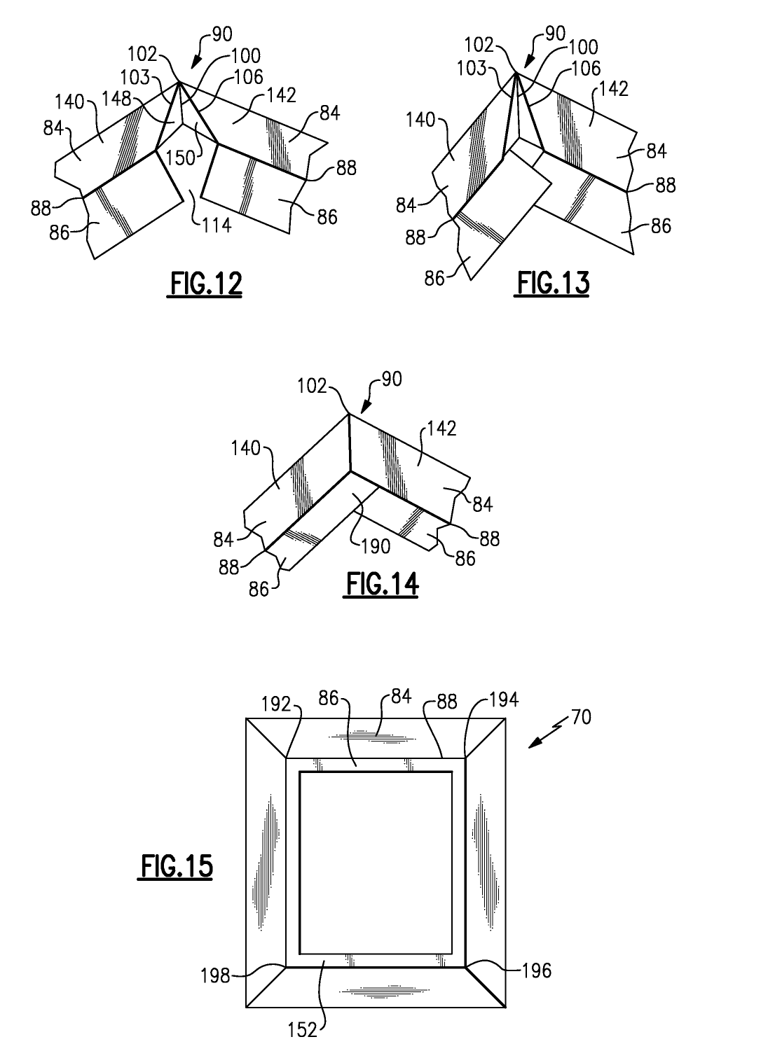

As shown in FIGS. 12, 13 and 14, the strip 74 is then folded to form the frame flange 70. The first section 140 and the second section 142 of the strip 74 are pivoted inwardly relative to the page about the point 102, folding the first score line 100 inwardly relative to the page, folding the second score line 103 and the third score line 106 outwardly relative to the page, and moving the triangles 148 and 150 inwardly towards each other until the triangles 148 and 150 contact. Adhesive, such as glue, can be placed on at least one of the contact faces of the triangles 148 and 150 to secure the surfaces together. A portion of the attachment portion 86 of the first section 140 and the second section 142 overlap at a location 190 and are secured. In one example, the location 190 is secured with an adhesive, such as glue. The first section 140 is perpendicular to the second section 142, and the first corner section 90 forms the first corner 192.

The second corner section 92 and the third corner section 94 are folded in the same manner to form a second corner 194 and a third corner 196, respectively. The half corner sections 96 and 98 are overlapped in a similar manner to form a fourth corner 198. When the strip 74 is folded, the corners 192, 194, 196 and 198 are located in the same relative position as the corners 44, 46, 48 and 50 of the filter cartridge 16. As the strip 74 is folded, the flange portion 84 is bent relative to the attachment portion 86 along the longitudinal score line 88 by an angle D° (shown in FIG. 16), forming a cantilever frame flange as shown in FIG. 15.

The flange portion 84 forms a flange that extends outwardly away from the attachment portion 86 to form a knife edge sealing surface. The flange portion 84 is flexible to provide a positive seal with the return air grille 14 and to prevent the leakage of bypass air around the filter cartridge 16.

As shown in FIG. 16, an inner surface 152 of the attachment portion 86 of the flange frame 70 is attached to the planar air entering surface 32 of the frame 28 by an adhesive 154, such as glue. The inner surface 152 of the attachment portion 86 forms a rectangle that corresponds to the shape of the frame 28.

The frame flange 70 is attached to all four surfaces 36, 38, 40 and 42 of the air entering surface 32 of the filter cartridge 16 and extends around the entire perimeter of the filter cartridge 16. When the frame flange 70 is attached to the frame 28, the attachment portion 86 of the frame flange 70 is located on only on one side 162 of a plane 164 defined by the air entering surface 32 of the frame 28. That is, the frame flange 70 is attached to and contacts a single surface of the filter cartridge 16, and the planar air entering surface 32 defines the entirety of the contact area of the frame flange 70 and the frame 28. The flange portion 83 extends towards the opposite side 166 of the plane 164 and engages the return air grille 14 to provide a seal.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A filter assembly comprising:
a filter cartridge including a frame and an air filter, wherein the frame has a planar surface surrounding the air filter that defines a plane; and
a frame flange attached to only the planar surface of the frame, wherein the filter cartridge and the frame flange are separate components.

2. The filter assembly as recited in claim 1 wherein the planar surface is an air entering surface that is substantially perpendicular to a direction of airflow towards the filter assembly.

3. The filter assembly as recited in claim 2 wherein the frame includes an opposing air exiting surface, and foam is applied to the opposing air exiting surface.

4. The filter assembly as recited in claim 1 wherein the frame flange surrounds an entire perimeter of the frame of the filter cartridge.

5. (canceled)

6. The filter assembly as recited in claim 1 wherein the frame flange is a single piece of material.

7. The filter assembly as recited in claim 1 wherein the frame flange is attached to the frame by an adhesive.

8. The filter assembly as recited in claim 1 wherein the frame flange is planar and is entirely located on one side of the plane defined by the planar surface.

9. The filter assembly as recited in claim 1 wherein the frame flange includes a cantilever flange portion that extends at an angle relative to the frame flange.

10. An HVAC system comprising:
a return air grille that receives a filter assembly;
the filter assembly including a filter cartridge including a frame, an air filter, and a frame flange, wherein the frame has a planar surface surrounding the air filter that defines a plane, the frame flange is attached to only the planar surface of the frame, and the filter cartridge and the frame flange are separate components;
a climate control device that that heats or cools air from the return air grille; and
a supply air grille that receives air from the climate control device.

11. The HVAC system as recited in claim 10 wherein the planar surface is an air entering surface that is substantially perpendicular to a direction of airflow towards the filter assembly.

12. The HVAC system as recited in claim 11 wherein the frame includes an opposing air exiting surface, and foam is applied to the opposing air exiting surface.

13. The HVAC system as recited in claim 10 wherein the frame flange surrounds an entire perimeter of the frame of the filter cartridge.

14.-15. (canceled)

16. The HVAC system as recited in claim 10 wherein the frame flange is attached to the frame by an adhesive.

17. The HVAC system as recited in claim 10 wherein the frame flange is planar and is entirely located on one side of the plane defined by the planar surface.

18. The HVAC system as recited in claim 10 wherein the frame flange includes a cantilever flange portion that extends at an angle relative to the frame flange.

19. A frame flange attachable to a filter cartridge, the frame flange comprising:
an attachment portion that is attachable to only a planar surface of a frame of a filter cartridge that surrounds an air filter, wherein the planar surface defines a plane.

20. The frame flange attachable to a filter cartridge as recited in claim 19 wherein the planar surface is an air entering surface that is substantially perpendicular to a direction of airflow towards the frame flange.

21. The frame flange attachable to a filter cartridge as recited in claim 19 wherein the frame flange surrounds an entire perimeter of the frame of the filter cartridge.

22.-23. (canceled)

24. The frame flange attachable to a filter cartridge as recited in claim 19 wherein the frame flange is planar and is entirely located on one side of the plane defined by the planar surface.

25. The frame flange attachable to a filter cartridge as recited in claim 19 wherein the frame flange includes a flange portion that extends at an angle relative to the frame flange.
